(19) United States
(12) Patent Application Publication
(10) Pub. No.: US 2024/0328925 A1
(43) Pub. Date: Oct. 3, 2024

(54) CUVETTE FOR BODY FLUID ANALYSIS

(71) Applicant: Hemocue AB, Angelholm (SE)

(72) Inventors: Per NILSSON, Angelholm (SE); Joakim PETTERSSON, Angelholm (SE); Johan RAHNBOY, Angelholm (SE)

(21) Appl. No.: 18/567,950

(22) PCT Filed: Dec. 20, 2022
(86) PCT No.: PCT/EP2022/086908

§ 371 Date: Dec. 7, 2023

(30) Foreign Application Priority Data
Dec. 23, 2021 (EP) 21217561.6

(51) Int. Cl. G01N 21/07; B01L 3/00

(52) U.S. Cl. CPC G01N 21/07; B01L 3/502; B01L 2200/0684; B01L 2400/0409

(57) ABSTRACT

Disclosed is cuvette for body fluid analysis. The cuvette comprising a sampling cavity comprising a fluid inlet, a sample analysis cavity, and a venting cavity being in fluid connection with the sampling cavity and the sample analysis cavity. The venting cavity has an outlet to the exterior of the cuvette. The cuvette is configured to transfer, when a centrifugal force is applied to the cuvette, a body fluid from the sampling cavity to the sample analysis cavity via the venting cavity. The sample analysis cavity is configured to provide a first capillary force, wherein the first capillary force is higher than a capillary force in the venting cavity. The sample analysis cavity is configured for separating and analyzing the body fluid sample.

The present disclosure pertains to the field of body fluid analysis, such as blood analysis. The present disclosure relates to a cuvette for taking up a body fluid sample and providing the body fluid sample to an analysis. The present disclosure also relates to a method of determining one or more biological parameters of a sample of body fluid.

### BACKGROUND

A cuvette is a small container being designed to hold liquid samples, such as body fluid samples, for spectroscopic/photometric measurements, where a beam of light may be passed through the sample within the cuvette to measure an absorbance, transmittance, fluorescence intensity, fluorescence polarization, fluorescence lifetime or reflectance, etc. of the sample to determine specific properties of the sample. These measurements may be done with an analysis apparatus, such as a spectrophotometer.

Typically, each property to be determined requires a respective cuvette with a corresponding body fluid sample. Thus, in order to analyze a plurality of properties, large quantities of the body fluid may be required. Further, each sample is typically analyzed independently. Thus, there is significant time delay between receiving a blood sample and providing analysis, which can slow down necessary patient care.

Typical cuvettes used for body fluid analysis may also be prone to spillage of the body fluid when manipulating the cuvette, in particular upon removal of the cuvette from the analysis apparatus and subsequent disposal, such as after analysis of the blood sample where the handling of the cuvette may be done more hastily. This may lead to reduced availability of the analyzing equipment, since time may have to be spent on cleaning the equipment from body fluid spillage between analysis runs.

Therefore, there is a need for new approaches that enable accurate and fast body fluid analysis.

### SUMMARY

Accordingly, there is a need for a cuvette, which mitigates, alleviates or addresses the shortcomings existing and provides improved user friendliness, improved analysis quality and reduces the time required for performing body fluid analysis.

Disclosed is cuvette for body fluid analysis. The cuvette comprises a sampling cavity comprising a fluid inlet, a sample analysis cavity, and a venting cavity being in fluid connection with the sampling cavity and the sample analysis cavity. The venting cavity has an outlet to the exterior of the cuvette. The cuvette is configured to transfer, e.g. when a force such as a centrifugal force is applied to the cuvette, a body fluid from the sampling cavity to the sample analysis cavity via the venting cavity. The sample analysis cavity is configured to provide a first capillary force, wherein the first capillary force is higher than a second capillary force provided by the venting cavity. The sample analysis cavity is configured for separating and analyzing the body fluid sample

Disclosed is a method of determining one or more biologically parameters of a sample of a body fluid. The method comprises introducing a sample of a body fluid in the sampling cavity of a cuvette as disclosed herein. The method comprises applying a force, such as a centrifugal force, to the cuvette thereby facilitating transfer of the body fluid from the sampling cavity to the sample analysis cavity via the venting cavity. The method comprises determining one or more biologically relevant parameters of the sample.

It is an advantage of the present disclosure that the cuvette enables a measurement of a property, such as a gap depth, of the sample analysis cavity of a cuvette comprising a body fluid sample prior to starting an analysis of the body fluid sample. By providing two cavities in the cuvette, such as the sampling cavity for taking up and holding the sample and the sample analysis cavity for performing the analysis of the sample, a measurement may be performed on the empty sample analysis cavity prior to transporting the body fluid sample to the sample analysis cavity. By measuring the properties of the empty sample analysis cavity, an analysis apparatus may be calibrated to each cuvette prior to analyzing the body fluid sample. Thereby a quality of the analysis can be improved.

Further, by providing a cuvette having a sample analysis cavity with a first capillary force being higher than the second capillary force in the venting cavity, the body fluid sample is prevented from escaping the sample analysis cavity. This ensures that a predefined volume of body fluid remains in the sample analysis cavity and can be used for the analysis. This can improve the quality of the analysis and can reduce the volume of body fluid required for the analysis. Further, preventing body fluid from escaping the sample analysis cavity reduces leakage of body fluid to an outside of the cuvette which may contaminate the surroundings of the cuvette, such as an analysis apparatus, during centrifugation of the cuvette or upon removal of the cuvette from the analysis apparatus, or may contaminate the surroundings when disposing the cuvette. Thereby, the time for cleaning the analysis apparatus may be reduced, which reduces the downtime between analysis sessions and allows the analysis apparatus to be used more efficiently.

Further, the current disclosure provides a cuvette that is simple and cost-efficient to manufacture.

Further, the cuvette according to the present disclosure has the advantage that the same body fluid sample and cuvette may be used for analyzing a plurality of different biological parameters of the body fluid sample, thereby providing faster and more accurate results.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 illustrates a perspective view of an example cuvette according to this disclosure,

FIG. 2 illustrates a schematic view of an example cuvette as disclosed herein,

FIG. 3 illustrates a schematic view of an example cuvette comprising cut lines indicating section views of the example cuvette as disclosed herein,

FIG. 4A illustrates a schematic first cut view of an example cuvette along a cut line A-A as disclosed herein,

FIG. 4B illustrates a schematic first cross-section view of an example cuvette along the cut line A-A as disclosed herein,

FIG. 5A illustrates a schematic second cut view of an example cuvette along a cut line B-B as disclosed herein,

FIG. 5B illustrates a schematic second cross-section view of an example cuvette along the cut line B-B as disclosed herein,

FIG. 6 illustrates a schematic third cross-section view of an example cuvette along a cut line C-C as disclosed herein,

FIG. 7 illustrates a schematic fourth cross-section view of an example cuvette along a cut line D-D as disclosed herein,

FIG. 8 illustrates a schematic of an example cuvette comprising an indicator according to this disclosure,

FIG. 9 illustrates a schematic view of an example cuvette according to this disclosure, and

FIG. 10 is a flow diagram illustrating an example method for determining one or more biological parameters of a body fluid according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A cuvette for body fluid analysis, such as blood analysis is disclosed. The cuvette is configured for taking up a body fluid sample, such as a blood, plasma, serum and/or urine sample, and to provide the body fluid sample to an analysis, such as to an analysis apparatus. In examples herein, the cuvette is particularly adapted for taking up samples of whole blood. The analysis apparatus may be configured for centrifuging the body fluid sample and to determine a biological parameter of the body fluid sample. The cuvette comprises a sampling cavity comprising a fluid inlet for taking up, such as obtaining, the body fluid sample, a sample analysis cavity for analyzing the body fluid sample, and a venting cavity.

The venting cavity is in fluid connection with the sampling cavity and the sample analysis cavity, such that a body fluid can flow from the sampling cavity to the sample analysis cavity via the venting cavity. The sampling cavity and the sample analysis cavity are not in direct fluid communication with each other. Hence, for the body fluid sample to move from the sampling cavity to the sample analysis cavity, the body fluid sample must flow through the venting cavity.

The cuvette is configured to transfer, upon a force, such as a centrifugal force, being applied to the cuvette, the body fluid sample from the sampling cavity to the sample analysis cavity via the venting cavity. In one or more example cuvettes, the cuvette is configured to transfer the body fluid sample from the sampling cavity to the sample analysis cavity via the venting cavity while the centrifugal force is applied to the cuvette, for example during a single centrifugation step. In one or more example cuvettes, the cuvette has a first interface fluidly connecting the venting cavity with the sampling cavity. The first interface may be configured to allow the body fluid sample to flow through the first interface when a centrifugal force overcoming the capillary force of the sampling cavity, such as a third capillary force, is applied to the cuvette. In one or more example cuvettes, the cuvette has a second interface fluidly connecting the venting cavity with the sample analysis cavity. The second interface may be configured to allow the body fluid sample to flow through the second interface from the venting cavity to the sample analysis cavity and may prevent a flow from the sample analysis cavity to the venting cavity. In one or more example cuvettes, the body fluid sample may spontaneously flow through the second interface, for example due to the first capillary force of the sample analysis cavity being higher than a second capillary force provided by the venting cavity. In one or more example cuvettes, the cuvette is absent of any means, such as capillary channels and/or siphons, configured to draw the body fluid sample away from the sample analysis cavity.

The body fluid sample, such as the body fluid sample introduced into the cuvette via the sampling cavity, may be separated in the sample analysis cavity by further application of a centrifugal force once the body fluid sample has entered the sample analysis cavity. For example, red blood cells may be separated out from a whole blood sample or disturbing elements may be separated out from a sample of urine. In other words, the body fluid sample may be separated and analyzed in the same cavity, such as in the sample analysis cavity. The sample analysis cavity may, in one or more example methods, also act as a centrifugal cavity.

In one or more example cuvettes, the sample analysis cavity is the innermost cavity of the cuvette. Thereby, the separated body fluid is arranged in the innermost cavity of the cuvette, which reduces the risk of the separated body fluid being contaminated by coming into contact with the outside of the cuvette.

In one or more example cuvettes, the first interface and the second interface are arranged at an angle to each other. The first interface may be arranged along a first axis, such as along a longitudinal axis, of the cuvette. The second interface may be arranged along a second axis, such as along a lateral axis, of the cuvette. The first interface and the second interface may for example be arranged substantially perpendicular to each other. Substantially perpendicular may herein be seen as being arranged at an angle in the range of 80-100 degrees, such as in the range of 85-95 degrees, to each other. However, other angles may also be envisaged. The second interface may in one or more example cuvettes, be arranged substantially perpendicular to the longitudinal direction of the cuvette, such as substantially perpendicular to a direction of a centrifugal force to be applied to the cuvette.

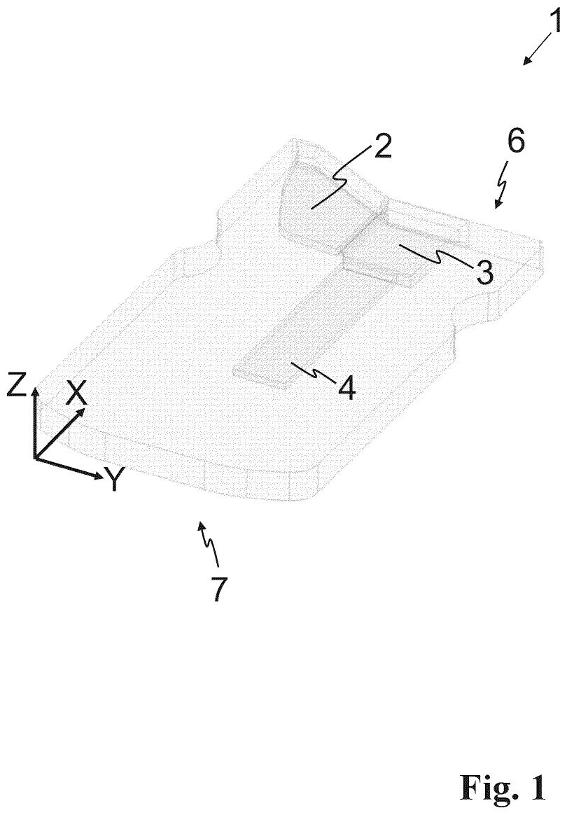

The sample analysis cavity is configured to provide a first capillary force, the first capillary force being higher than the second capillary force provided by the venting cavity. The first capillary force may be achieved by a height and/or a width of the sample analysis cavity being smaller than a capillary force achieved by a height and/or a width of the venting cavity. The height of the sample analysis cavity and the venting cavity may herein be seen as a distance between a first inner surface and a second inner surface of the respective cavity in a vertical direction of the cuvette, as defined in FIG. 1. By decreasing the distance between the inner surfaces of the cavity, the capillary force of the cavity may be increased. By configuring the sample analysis cavity to have a higher capillary force than the venting cavity, i.e., the first capillary force being larger than the second capillary force, a transport of the body fluid sample from the venting cavity to the sample analysis cavity may be enhanced, while a transport of the fluid from the sample analysis cavity to the venting cavity may be prevented. The cuvette may thus be configured to prevent the body fluid sample from leaving the sample analysis cavity after the centrifugal force is removed.

Thereby, it can be ensured that the entire volume of the body fluid sample remains in the sample analysis cavity after the centrifugal force has been removed from the cuvette. The entire volume can herein be seen as at least 90%, such as 95%, 96%, 97%, 98%, 99%, or 100% of the volume of body fluid obtained by the sampling cavity.

The venting cavity has an opening to the exterior of the cuvette, which opening may herein be referred to as a venting opening. The venting opening may form an outlet through which air can be vented from the sample analysis cavity to the exterior of the cuvette via the venting cavity upon the sample analysis cavity being filled with the body fluid sample. The cuvette may be configured to transfer, when a body fluid is introduced into, such as taken up by, the sampling cavity, air from the sampling cavity to an exterior of the cuvette via the venting cavity and/or via the sampling cavity.

The venting opening may in one or more example cuvettes be arranged at a first end of the cuvette. The venting opening may cover an entire width of the venting cavity, such that an entire side of the venting cavity may be open to the exterior of the cuvette.

In one or more example cuvettes, the venting opening is an opening through an outer side wall of the cuvette. The venting opening may extend over a part of or an entire width of the venting cavity. The opening allows air to escape from any of the cavities, such as the venting cavity, the sampling cavity and/or the sample analysis cavity, through the venting cavity to an exterior of the cuvette, when the cavity is filled with the body fluid sample. In one or more example cuvettes, the outlet of the venting cavity to the exterior of the cuvette is arranged at a first end of the cuvette, such as at a first longitudinal end of the cuvette.

In one or more example cuvettes, the sampling cavity has an opening through an outer side wall of the cuvette, which opening may herein be referred to as a sampling opening. The sampling opening may extend over a part of or an entire width of the sampling cavity. The sampling opening can allow air to escape from the sampling cavity when the sampling cavity takes up, such as is filled with, the body fluid sample. In one or more example cuvettes, the sampling opening of the sampling cavity to the exterior of the cuvette is arranged at the first end of the cuvette. The sampling opening and the venting opening may thus be arranged at the same end of the cuvette.

In one or more example cuvettes, the venting opening and/or the sampling opening extending over the entire width of the respective cavities can allow a removal of a shaping tool being used during manufacturing of the cuvette. Thereby manufacturing of the cuvette may be facilitated which can reduce a time and a cost for manufacturing the cuvette.

The sampling cavity may be configured to provide a third capillary force. The third capillary force may be higher than the second capillary force in the venting cavity. By configuring the cuvette such that the third capillary force is higher than the second capillary force, a spontaneous transport of the body fluid sample from the sampling cavity can be prevented. Spontaneous transport herein means a transport without application of an external force, such as a centrifugal force, to the cuvette. The higher capillary force in the sampling cavity may be achieved by the sampling cavity having a height being smaller than the height of the venting cavity. The height of the cavity may herein be seen as a distance between two parallel inner surfaces of the respective cavities. The third capillary force of the sampling cavity may be the same as or different than the first capillary force. Since the cuvette is configured such that a spontaneous transport of the body fluid from the sampling cavity is prevented, the sampling cavity may be filled with a sample in several steps without obtaining excess fluid. Thus, in case the sampling cavity has not been properly filled, more fluid may be drawn into the sampling cavity for filling up the sampling cavity. Hence, if it is noted that the inlet cavity is not completely filled with fluid, the cuvette may again be brought in contact with a fluid to be sampled such that more fluid will be drawn into the inlet cavity by capillary action in the sampling cavity. Thereby a pre-defined sample volume corresponding to the volume of the sampling cavity can always be acquired.

In one or more example cuvettes, the cuvette consists of a main body member, such as a single main body member, having inner walls defining the sampling cavity, the sample analysis cavity, and the venting cavity within the body. A single body member can herein be seen that the cuvette is made of one integral part, for example by molding or casting. By making the cuvette as an integral part, the cuvette does not comprise any joints through which the body fluid may escape the cuvette during centrifugation. Thereby contamination of the outside of the cuvette and the analysis apparatus can be reduced, which reduces the time needed between analyses for cleaning and preparing the analysis apparatus for receiving another cuvette.

The sampling cavity, the sample analysis cavity and the venting cavity may be arranged in a main body member of the cuvette. The main body member of the cuvette may be made of a material having a low absorbance of radiation in wavelengths used during analysis of the body fluid sample. In one or more example cuvettes, the material of the cuvette may be a plastic, such as polystyrene (PS), polymethylmethacrylate (PMMA), or polycarbonate (PC).

The centrifugal force being applied to the cuvette may overcome the third capillary force holding the body fluid sample in the sampling cavity. The body fluid sample may thus leave the sampling cavity via the venting cavity and may enter the sample analysis cavity.

The sample analysis cavity may be arranged offset from the sampling cavity in the longitudinal direction of the cuvette. Thereby, the centrifugal force may force the body fluid sample towards and into the sample analysis cavity.

In one or more example cuvettes, the sample analysis cavity has, such as is configured to provide, a higher capillary force than any neighboring cavities, such as the venting cavity.

Neighboring cavities can herein be seen as cavities being in direct fluid connection with the sample analysis cavity. In other words, the sample analysis cavity may not be in direct fluid connection with a cavity having a higher capillary force than the sample analysis cavity itself.

The cuvette may be configured to transfer, upon the centrifugal force being applied to the cuvette, air from the sample analysis cavity to an exterior of the cuvette via the venting cavity. Upon the body fluid sample entering the sample analysis cavity, air in the sample analysis cavity may escape the sample analysis cavity to an exterior of the cuvette via the second interface and the venting opening, thereby ensuring a proper filling of the sample analysis cavity.

In one or more example cuvettes, the sampling cavity and the sample analysis cavity have equal volumes, such as substantially equal volumes. Thereby, a predefined volume of the body fluid sample may be obtained by the sampling cavity and the same volume of the fluid can be separated and/or analyzed in the sample analysis cavity.

The volume of the sampling cavity may be in the range of 10-100 microliters (μL), or 20-60 microliters (μL), such as in the range of 30-50 μL, such as in the range of 30-40 μL, such as in the range of 30-35 μL, such as 32 μL. The volume of the sample analysis cavity may be in the range of 10-100 microliters (μL), such as 20-60 microliters (μL), such as in the range of 30-50 μL, such as in the range of 30-40 μL, such as in the range of 30-35 μL, such as 32 μL.

In one or more example cuvettes, the sample analysis cavity has a substantially uniform elongated shape extending in a first direction between the first end and an opposing second end of the cuvette. The first end and the second end of the cuvette may be arranged at opposing longitudinal ends of the cuvette. The first direction may be parallel to an intended direction of the centrifugal force to be applied to the cuvette, such as to the direction of the centrifugal force applied to the cuvette when the cuvette is analyzed using an analysis apparatus configured to receive the cuvette.

In one or more example cuvettes, an overall length of the cuvette, such as an extension in the longitudinal direction of the cuvette as defined in FIG. 1, may be in the range of 30-50 mm, or 36-44 mm, such as in the range of 38-42 mm, such as in the range of 39-40 mm. The overall length may be measured from the tip of the first longitudinal end of the cuvette to the second longitudinal end of the cuvette.

In one or more example cuvettes, an overall width of the cuvette, such as an extension in a lateral direction of the cuvette as defined in FIG. 1, may be in the range of 15-28 mm, or 18-24 mm, such as in the range of 19-23 mm, such as in the range of 20-22 mm. In one or more example methods, the width of the cuvette may be 21 mm.

In one or more example cuvettes, an overall width of the cuvette, such as an extension in a vertical direction of the cuvette as defined in FIG. 1, may be in the range of 1.9-2.4 mm, such as in the range of 2.0-2.3 mm, such as in the range of 2.1-2.2 mm.

In one or more example cuvettes, the sample analysis cavity may have a length, such as an extension in the longitudinal direction, such as in the X-direction, of the cuvette as defined in FIG. 1, in the range of 10-20 mm, such as 10 mm, 11 mm, 12 mm, 13 mm, 14 mm, 15 mm, 16 mm, 17 mm, 18 mm, 19 mm or 20 mm, and/or any ranges constrained by the dimensions discussed in this paragraph.

In one or more example cuvettes, the sample analysis cavity may have a width, such as an extension in a lateral direction, such as in the Y-direction, of the cuvette as defined in FIG. 1, in the range of 2-7 mm, such as 2 mm, 3 mm, 4 mm, 5 mm, 6 mm or 7 mm, and/or any ranges constrained by the dimensions discussed in this paragraph.

In one or more example cuvettes, the sample analysis cavity may have a height, such as an extension in a vertical direction, such as in the Z-direction, of the cuvette as defined in FIG. 1, in the range of 0.2-0.7 mm, such as 0.2 mm, 0.3 mm, 0.4 mm, 0.5 mm, 0.6 mm or 0.7 mm, and/or any ranges constrained by the dimensions discussed in this paragraph. In one or more example cuvettes, the height of the sample analysis cavity may be 0.5 mm, such as 500 μm.

In one or more example cuvettes, the sampling cavity may have a length, such as an average length, in the range of 5-15 mm, such as 5 mm, 6 mm, 7 mm, 8 mm, 9 mm, 10 mm, 11 mm, 12 mm, 13 mm, 14 mm or 15 mm, and/or any ranges constrained by the dimensions discussed in this paragraph. The length of the sampling cavity can be seen as the an extension in the longitudinal direction, such as in the X-direction, of the cuvette as defined in FIG. 1

In one or more example cuvettes, the sampling cavity may have a width, such as an extension in a lateral direction, such as in the Y-direction of the cuvette as defined in FIG. 1, such as an average width, in the range of 5-15 mm, such as 5 mm, 6 mm, 7 mm, 8 mm, 9 mm, 10 mm, 11 mm, 12 mm, 13 mm, 14 mm or 15 mm, and/or any ranges constrained by the dimensions discussed in this paragraph.

In one or more example cuvettes, the sampling cavity may have a height, such as an extension in a vertical direction, such as in the Z-direction, of the cuvette as defined in FIG. 1, in the range of 0.2-0.7 mm, such as 0.2 mm, 0.3 mm, 0.4 mm, 0.5 mm, 0.6 mm or 0.7 mm, and/or any ranges constrained by the dimensions discussed in this paragraph. In one or more example cuvettes, the height of the sampling cavity may be in the range of 200-700 μm, such as 500-650 μm, such as 592 μm or 575 μm.

In one or more example cuvettes, the venting cavity may have a length, such as an extension in the longitudinal direction, such as in the X-direction, of the cuvette as defined in FIG. 1, in the range of 5-10 mm, such as 5 mm, 6 mm, 7 mm, 8 mm, 9 mm, or 10 mm, and/or any ranges constrained by the dimensions discussed in this paragraph.

In one or more example cuvettes, the venting cavity may have a width, such as an extension in the y-direction of the cuvette as defined in FIG. 1, in the range of 3-8 mm, such as 3 mm, 4 mm, 5 mm, 6 mm, 7 mm, or 8 mm, and/or any ranges constrained by the dimensions discussed in this paragraph.

In one or more example cuvettes, the venting cavity may have a height, such as an extension in a vertical direction, such as in the Z-direction, of the cuvette as defined in FIG. 1, in the range of 0.4-2 mm, such as 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, or 2.0 mm, and/or any ranges constrained by the dimensions discussed in this paragraph. In one or more example cuvettes, the height of the venting cavity may be 1 mm, such as 1000 μm.

In one or more example cuvettes, the body member comprises a tip. The sampling cavity may be arranged at the tip of the body member, such that the inlet of the sampling cavity is arranged at the tip of the cuvette. By arranging the inlet at the tip of the cuvette filing of the sampling cavity with a body fluid sample can be facilitated, since the tip allows a precise positioning of the inlet of the sampling cavity at a blood sample to be taken up.

In one or more example cuvettes, the sampling cavity, such as an inner surface of the sampling cavity, is configured to slope towards the sample analysis cavity. By providing the sampling cavity with a slope the transportation of the body fluid sample from the sampling cavity to the sample analysis cavity may be improved. The sampling cavity may be configured to slope outwards towards the opening of the further facilitates removal of a shaping tool after shaping of the cuvette.

In one or more example cuvettes, the cuvette, such as the sample analysis cavity of the cuvette, is free of reagents. When the cuvette is free of reagents, the analysis of the body fluid sample, such as the blood sample, may be done by measuring directly at the hemoglobin (Hb) derivates comprised in the body. For blood, the hemoglobin derivatives may be for example reduced hemoglobin (Hb), such as deoxyhemoglobin (reduced), oxyhemoglobin (HbO2), methemoglobin (met-Hb), carboxyhemoglobin (HbCO) or other types of hemoglobin. The different hemoglobin derivatives may have different absorbances in different wavelengths and therefore optics, such as photometers, and algorithms for determining parameters of the blood may be configured to compensate for interferences caused by the different hemoglobin derivates at the different wavelengths. Making the cuvette free of reagents reduces the cost of manufacturing the cuvette and also reduces the time it takes to manufacture the cuvette. By making the cuvette reagent free, the number of cavities in the cuvette can be reduced since no reaction between the separated blood and a reagent has to take place. Thereby the complexity of the cuvette can be reduced which facilitates manufacturing and use of the cuvette. Furthermore, by making the cuvette reagent free the cuvette is insensitive to air humidity which allows the cuvette to be shipped without a sealed packaging. This has the benefit that the effort and cost for producing the cuvette can be reduced.

In one or more example cuvettes, the walls of the sampling cavity are coated with a wetting agent. The wetting agent may aid in taking up blood samples in the sampling cavity.

In one or more example cuvettes, the sample analysis cavity may comprise a reagent configured to react with the body fluid sample. The reagent may be arranged on an inner surface of the sample analysis cavity, such that it comes in contact with the body fluid sample when the body fluid sample enters the sample analysis cavity. The reagent may be applied to the sample analysis cavity during manufacturing of the cuvette. Different reagents may be provided in the cavity depending on the analysis that is to be performed, thereby enabling the cuvette to be adapted for analysis of different biological parameters of a body fluid and for different types of body fluids. When the body fluid sample is blood, the reagent may cause the different hemoglobin derivates to react into the same derivate, thereby reducing interference at the different wavelengths which may facilitate the analysis procedure of the blood sample.

In one or more example cuvettes, the cuvette may comprise a unique identifier for identifying each respective cuvette. The unique identifier may be a visual identifier, such as a barcode or a QR-code, or a digital identifier, such as a Radio Frequency Identification (RFID) tag. The unique identifier may be used to identify the cuvette being used for a specific body fluid sample and/or analysis. In one or more example cuvettes, the identifier may be identified by the analysis apparatus and measurements from the analysis apparatus may be automatically stored with the unique identifier of the cuvette.

In one or more example cuvettes, such as when the body fluid is blood, the cuvette may comprise an indicator for indicating a hematocrit level of the body fluid sample. The indicator may be arranged along an outer periphery of the sample analysis cavity. In one or more example cuvettes, the indicator for indicating a hematocrit level of the body fluid sample may be arranged partly or fully overlapping with the sample analysis cavity. Since the cuvette may be configured for performing separation of a body fluid sample, such as plasma separation of a blood sample, a hematocrit level indicator may be added on the cuvette. The sampling cavity is configured to extract a precise body fluid volume and the cuvette is configured to transport the entire sample from the sampling cavity to the sample analysis cavity. Thereby, a known volume of body fluid may be provided to the sample analysis cavity. Therefore, measurement lines may be added in the cuvette to provide a visual indication of the hematocrit level. The measurement lines may be added by one or more of laser welding, etching, and engraving in the cuvette, or during a molding procedure of the cuvette. Upon an operator extracting the cuvette from the analysis apparatus after centrifugation a visual indication of the hematocrit level can be read based on the hematocrit level indicator at the cuvette. The hematocrit level indicator on the cuvette has the benefit that it may provide an indication for disorders such as Anemia or Polycythemia.

The cuvette may be a single-use cuvette, such as a cuvette configured for one time use, such as may be disposable and is to be thrown away after having been used once for analysis.

Further, a method of manufacturing a cuvette is disclosed. The cuvette may be configured for taking up a body fluid sample and for analyzing the body fluid sample. The method comprises providing a cuvette base material, from which the cuvette is to be formed. The material may be a plastic material having a low absorbance of radiation in wavelengths to be used during the analysis, such as polystyrene (PS), polymethylmethacrylate (PMMA), or polycarbonate (PC). The method comprises shaping, from the cuvette base material, a cuvette using at least one shaping tool. The shaping tool is arranged such that it extends into said cuvette base material for forming the cuvette. The cuvette may have a sampling cavity comprising a fluid inlet, a sample analysis cavity, and a venting cavity being in fluid connection with the sampling cavity and the sample analysis cavity. The method comprises withdrawing the shaping tool through an outer side wall of the cuvette. The shaping tool may in one or more example methods, be withdrawn through the outlets of the sampling cavity and/or the venting cavity.

In one or more example methods, the method comprises applying an indicator for indicating a hematocrit level of a body fluid sample on the cuvette. In one or more example methods, the shaping of the cuvette is performed by means of, such as using, injection molding. The indicator may be applied to the cuvette during the injection molding process, such as using a negative imprint on the molding tool, or may be applied by means of, such as using, one or more of laser welding, etching, and engraving. A negative imprint may herein be seen as an inverse shape of the part that is to be molded, such as of the indicator.

A shaping tool for forming the cuvette is disclosed. The shaping tool may be configured for insertion into a cuvette base material for forming cavities in the base material. The shaping tool may further be configured to be withdrawn from the cuvette base material when the cavities have been formed. The shaping tool comprises a sampling cavity part having an inverse shape of the sampling cavity of the cuvette. The shaping tool comprises a sample analysis cavity part having an inverse shape of the sample analysis cavity of the cuvette. The shaping tool comprises a venting cavity part having an inverse shape of a venting cavity of the cuvette, said venting cavity part being connected to the sampling cavity part and the sample analysis cavity part. The sampling cavity part and the sample analysis cavity part are not directly connected to each other.

In one or more example shaping tools, the sampling cavity part, the sample analysis cavity part, and the venting cavity part are arranged on a common shaping core, such as on a single shaping core.

In one or more example shaping tools, the shaping tool may comprise a first shaping core and a second shaping core. In one or more example shaping tools, one or more of the sampling cavity part, the sample analysis cavity part, and the venting cavity part are arranged on the first shaping core and one or more of the sampling cavity part, the sample analysis cavity part, and the venting cavity part are arranged on the second shaping core.

In one or more example shaping tools, a thickness of the venting cavity part is larger than a thickness of the sampling cavity part. In one or more example shaping tools, a thickness of the venting cavity part is larger than a thickness of the sample analysis cavity part.

A method of determining one or more biological parameters of a sample of a body fluid is disclosed. The method comprises introducing a sample of a body fluid into the sampling cavity of a cuvette as disclosed herein. The method comprises applying a centrifugal force, such as a first centrifugal force, to the cuvette, thereby facilitating transfer of the body fluid from the sampling cavity to the sample analysis cavity via the venting cavity. In one or more example methods, the method comprises applying a second centrifugal force, once the body fluid sample has entered the sample analysis cavity, to separate the body fluid sample comprised in the sample analysis cavity. The method comprises determining one or more biological parameters of the body fluid sample. Determining the one or more biological parameters of the body fluid sample may be done when the body fluid sample is in the sample analysis cavity.

In the following, the cuvette of the current disclosure will be described in further detail with reference to the figures. The figures are schematic in nature and simplified for clarity, and they merely show details which aid understanding the disclosure, while other details have been left out. Throughout, the same reference numerals are used for identical or corresponding parts.

FIG. 1 illustrates a perspective view of the cuvette 1 according to one or more examples of the current disclosure. The cuvette 1 comprises the sampling cavity 2, the venting cavity 3 and the sample analysis cavity 4. Throughout this document, the cuvette will be described in relation to the coordinate system disclosed in FIG. 1, where the X-axis defines a longitudinal direction spanning a length of the cuvette 1 (such as between a first longitudinal end 6 and a second longitudinal end 7 of the cuvette 1), the Y-axis defines a lateral direction spanning a width of the cuvette 1 and the Z-axis defines a vertical direction spanning a height of the cuvette 1. A main plane of the cuvette 1 as discussed herein is a plane extending in the longitudinal and lateral direction of the cuvette 1. A plane perpendicular to the main plane may herein be one or more of a plane extending in the longitudinal direction and the vertical direction of the cuvette 1 and a plane extending in the lateral direction and the vertical direction of the cuvette 1. The cuvette 1 may have a larger extension in the longitudinal and the lateral direction than in the vertical direction and may thus be referred to as a having a flat shape or as being a flat cuvette.

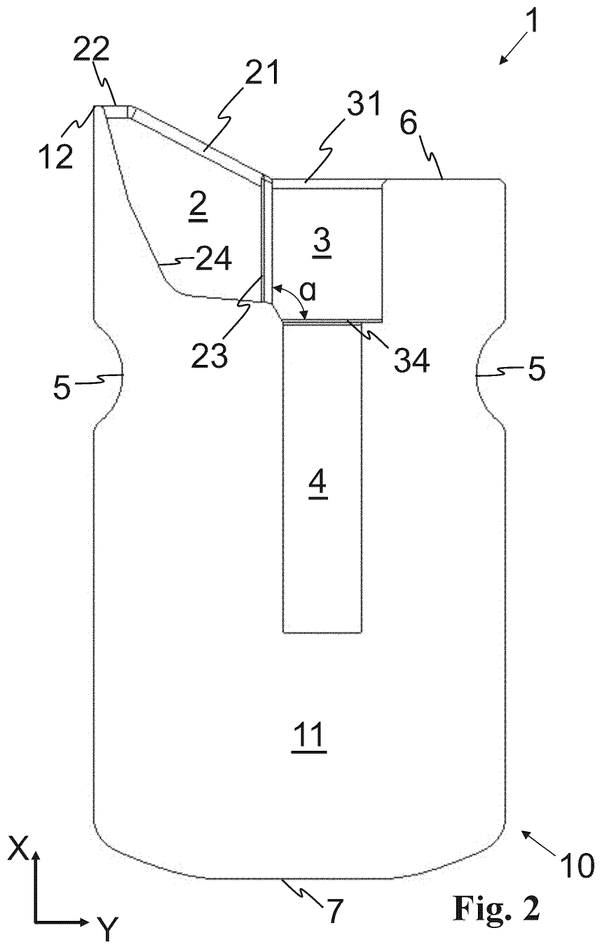

FIG. 2 illustrates a cuvette 1 according to one or more examples of the current disclosure. The cuvette 1 comprises the sampling cavity 2, the sample analysis cavity 4 and the venting cavity 3. The sampling cavity 2 comprises a fluid inlet 22 for collecting a body fluid sample. The cuvette 1 has a main body member 10, which comprises a base portion 11. The base portion 11 may be solid and may be configured to be touched by an operator during handling of the cuvette without causing any interference with the results of the analysis of the body fluid. In one or more example cuvettes, the base portion 11 of the main body member 10 may have a different surface texture than the main body member 10 in area of the sampling cavity 2 and/or the sample analysis cavity 4. Providing the base portion 11 with a different surface texture can provide the operator of the cuvette a visual indication of the areas that can be touched without interfering with the analysis result. For example, the surface in the area of the sampling cavity 2 and/or the sample analysis cavity 4 may be clear, while the surface of the base portion 11 may be frosted. The outer shape of the cuvette 1 may be configured such that the cuvette 1 can only be positioned in one way in the analysis apparatus. In one or more example cuvettes 1, the outer shape of the cuvette 1 is asymmetrical. The main body member 10 may comprise mounting elements 5 that may be configured to fit a cuvette holder in an analysis apparatus. The mounting elements 5 may be arranged such that the cuvette 1 can only be positioned in one way in the analysis apparatus. In the example cuvette 1 shown in FIG. 2, the mounting elements 5 may be shaped as indentations in an outer surface of the cuvette. The mounting elements 5 may thus be configured for mounting the cuvette 1 to the analysis apparatus, such as to a rotatable member of the analysis apparatus. In one or more example cuvettes, the outer surface of the cuvette 1 in the area of the sample analysis cavity 4 may be indented, such as may be lower than the surrounding areas of the outer surface of the cuvette 1. In other words, the outer surface of the cuvette 1 may be lower in the area of the sample analysis cavity 4 than in the area of the base portion 11 of the cuvette 1. Thereby, the outer surface in the area of the sample analysis cavity 4 may be protected from being contaminated, such as scratched, when the cuvette is handled or placed on a contaminated and/or rough surface.

The sampling cavity 2, the sample analysis cavity 4 and the venting cavity 3 are arranged in, such as may be formed in, the main body member 10 of the cuvette 1. The cuvette 1 may consist of a single main body member 10, such as an integral part, having inner walls defining the sampling cavity 2, the sample analysis cavity 4, and the venting cavity 3 within the main body member 10. The main body member 10 of the cuvette 1 may be made of a material having a low absorbance of radiation in wavelengths used during analysis of the body fluid sample. The main body member 10 may be made out of plastic, such as polystyrene (PS), polymethylmethacrylate (PMMA), or polycarbonate (PC).

The venting cavity 3 is in fluid connection with the sampling cavity 2 and the sample analysis cavity 4, such that a body fluid can flow from the sampling cavity 2 to the sample analysis cavity 4 via the venting cavity 3. The venting cavity 3 may be fluidly connected with the sampling cavity 2 via a first interface 23. The first interface 23 may be arranged along a longitudinal axis of the cuvette 1. The venting cavity 3 may be fluidly connected with the sample analysis cavity 4 via a second interface 34. The second interface 34 may be arranged along a lateral axis of the cuvette 1. The sampling cavity 2 and the sample analysis cavity 4 are not in direct fluid communication with each other. Hence, for the body fluid sample to move from the sampling cavity 2 to the sample analysis cavity 4, the body fluid sample must flow through the venting cavity 3, such as via the first interface 23 and the second interface 34.

The sample analysis cavity 4 is configured to provide a first capillary force, the first capillary force being higher than a second capillary force provided by the venting cavity 3. This may be achieved by the height of the sample analysis cavity 4 being smaller than the height of the venting cavity 3. The second interface 34 may be configured to allow the body fluid sample to flow through the second interface 34 from the venting cavity to the sample analysis cavity and prevent a flow of the body fluid sample from the sample analysis cavity 4 to the venting cavity 3. This ensures that the entire volume of the body fluid sample enters and remains in the sample analysis cavity 4.

The first interface 23 and the second interface 34 may be arranged at an angle α to each other. The first interface 23 and the second interface 34 may for example be arranged substantially perpendicular to each other.

The sampling cavity 2 is configured to provide a third capillary force, wherein the third capillary force is higher than the second capillary force. The third capillary force being higher than the second capillary force prevents spontaneous transport of the body fluid sample from the sampling cavity 2 to the venting cavity 3. This may be achieved by the height of the sampling cavity 2 being smaller than the height of the venting cavity 3. The third capillary force may be the same as or different than the first capillary force. The first interface 23 may be configured to allow the body fluid sample to flow through the first interface 23 when a centrifugal force overcoming the third capillary force is applied to the cuvette 1. The cuvette 1 may thus be configured to transfer, upon a centrifugal force being applied to the cuvette 1, the body fluid sample from the sampling cavity 2 to the sample analysis cavity 4 via the venting cavity 3.

The body fluid sample introduced into the cuvette 1 via the sampling cavity 2 may be separated in the sample analysis cavity 4 by further application of a centrifugal force, such as a second centrifugal force, once the body fluid sample has entered the sample analysis cavity 4.

The venting cavity 3 has an outlet 31 to the exterior of the cuvette 1. The outlet 31 of the venting cavity 3 may be arranged at a first end 6, such as a first longitudinal end, of the cuvette 1. The outlet 31 may be an opening through a first outer side wall at the first end 6 of the cuvette 1, said opening extending over an entire width of the venting cavity 3.

Thereby, an entire side of the venting cavity 3 may be open to the exterior of the cuvette 1. The outlet 31 is configured to allow air to be vented from the sample analysis cavity 4 to the exterior of the cuvette 1 via the venting cavity 3 upon the sample analysis cavity 4 being filled with the body fluid sample. The outlet 31 covering the entire width of the venting cavity 3 also allows a shaping tool to be removed from the main body member 10 after manufacturing of the cuvette 1.

The sampling cavity 2 has an opening 21 through the first outer side wall at the first end 6 of the cuvette 1. The opening 21 extends over the entire width of the sampling cavity 2. The opening 21 in the sampling cavity 2 can allow air to escape from the sampling cavity when the sampling cavity 2 takes up, such as is filled with, the body fluid sample. The opening 21 can further allow a removal of the shaping tool used during manufacturing of the cuvette 1. The opening 21 of the sampling cavity 2 can be arranged at the same end of the cuvette 1 as the outlet 31. The main body member 10 may comprise a tip 12. The tip 12 may be arranged at the first end 6. The side wall at the first end 6 may comprise a bend forming the tip 12. The sampling cavity 2 may be arranged at the tip 12 of the main body member 10, such that an inlet 22 of the sampling cavity 2 is arranged at the tip 12 of the cuvette 1. By arranging the inlet 22 at the tip 12 of the cuvette 1, a filing of the sampling cavity with a body fluid sample can be facilitated, since the tip 12 allows a precise positioning of the inlet 22 at a body fluid sample to be taken up. When the tip 12 is dipped into a body fluid sample the capillary force of the sampling cavity 2 will cause the body fluid to be drawn into the sampling cavity 2 via the inlet 22. The inlet 22 may be a section of the opening 21 arranged at the tip 2 of the cuvette 1. The sampling cavity 2, such as an inner surface 24 of the sampling cavity 2, may be configured to slope towards the sample analysis cavity 4. By providing the sampling cavity 2 with a sloped inner surface 24, the transportation of the body fluid sample from the sampling cavity 2 to the sample analysis cavity 4 may be improved. The sampling cavity 2, such as the inner surface 24, may be configured to slope outwards towards the opening 21. Thereby, the removal of the shaping tool after shaping of the cuvette 1 may be facilitated.

The sample analysis cavity 4 may have a substantially uniform elongated shape extending in a first direction from the first end 6 of the cuvette 1 to an opposing second end 7 of the cuvette 1. The first end 6 and the second end 7 of the cuvette may be arranged at opposing longitudinal ends of the cuvette 1. The first direction may be parallel to an intended direction of the centrifugal force to be applied to the cuvette, such as to the direction of the centrifugal force applied to the cuvette when the cuvette is analyzed using an analysis apparatus configured to receive the cuvette 1.

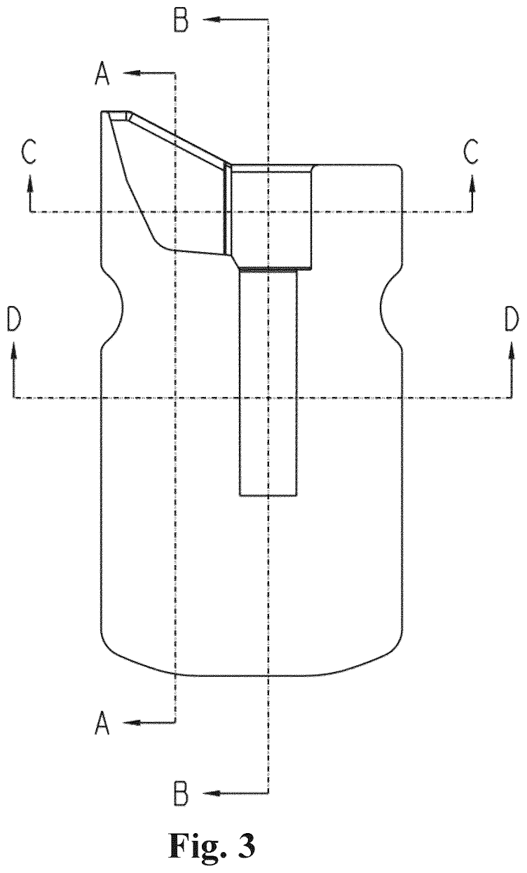

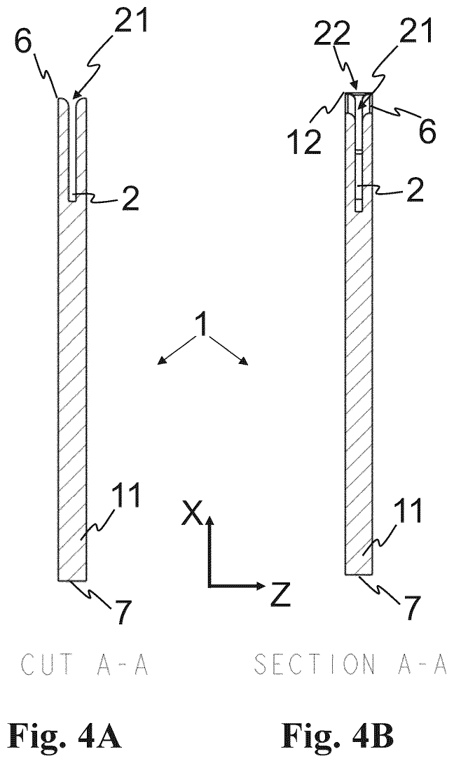

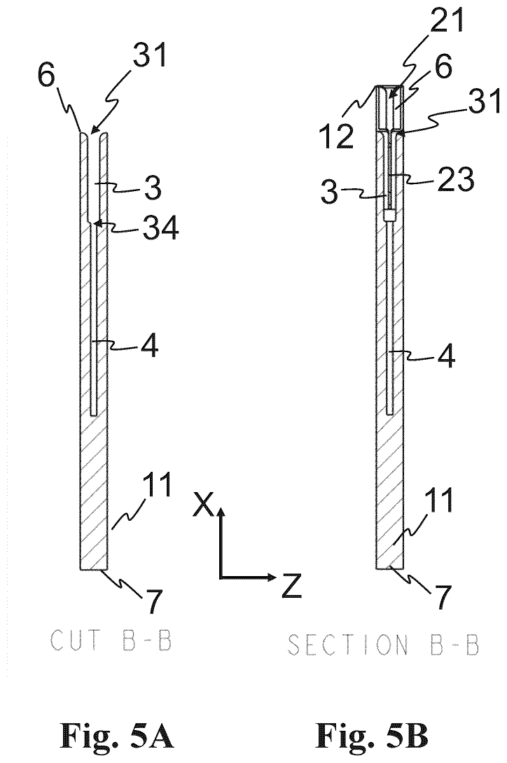

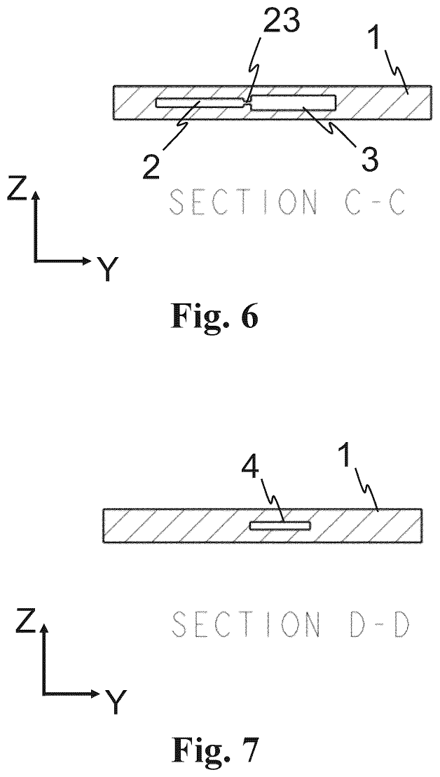

In one or more example cuvettes, the sample analysis cavity 4 may be offset from the sampling cavity 2 in the longitudinal direction of the cuvette 1. In one or more example cuvettes, the sample analysis cavity 4 may be offset from the sampling cavity 2 in the lateral direction of the cuvette 1. In one or more example cuvettes, the sample analysis cavity 4 may be offset from the sampling cavity 2 in the longitudinal direction of the cuvette 1 and in the lateral direction of the cuvette 1. FIG. 3 illustrates a position of a first cutting plane A-A, a second cutting plane B-B, a third cutting plane C-C and a fourth cutting plane D-D used for the section views in FIGS. 4-7. The cutting plane A-A extends in a longitudinal direction of the cuvette through the sampling cavity 2. The section view in the cutting plane A-A will be further described with reference to FIGS. 4A and 4B. The cutting plane B-B extends in a longitudinal direction of the cuvette through the venting cavity 3 and the sample analysis cavity 4. The section view in the cutting plane B-B will be further described with reference to FIGS. 5A and 5B. The cutting plane C-C extends in a lateral direction of the cuvette 1 through the venting cavity 3 and the sampling cavity 2. The section view in the cutting plane C-C will be further described with reference to FIG. 6. The cutting plane D-D extends in a lateral direction of the cuvette 1 through the sample analysis cavity 4. The section view in the cutting plane D-D will be further described with reference to FIG. 7.

FIG. 4A shows a cut view and FIG. 4B shows a section view of the cuvette 1 through the cutting plane A-A. As can be seen in the cut view of FIG. 4A, the sampling cavity 2 is arranged in the main body 11 at the first end 6 of the cuvette 1. The sampling cavity 2 has the opening 21 through the outer side wall of the cuvette 1 at the first end 6.

The section view of FIG. 4B shows the cross section of the cuvette seen facing the tip 12 of the cuvette 1. As can be seen, the opening 21 of the sampling cavity 2 extends over the entire width of the sampling cavity 2 to the inlet 22 arranged at the tip 12.

FIG. 5A shows a cut view and FIG. 5B shows a section view of the cuvette 1 through the cutting plane B-B. The venting cavity 3 is arranged at the first end 6 of the cuvette 1 and extends between the first end 6 and the sample analysis cavity 4. The sample analysis cavity 4 extends in the longitudinal direction from the venting cavity 3 towards the second end 7 of the cuvette 1. As can be seen in the cut view in FIG. 5A, the sample analysis cavity 4 is narrower than the venting cavity 3, such as has a smaller height than the venting cavity 3. Due to the sample analysis cavity 4 having a smaller height than the venting cavity 3, the first capillary force is higher than the second capillary force. Thereby, a transport of the body fluid sample from the venting cavity 3, through the second interface 34 to the sample analysis cavity 4 can be enhanced as the first capillary force will suck the body fluid sample into the sample analysis cavity 4. The first capillary force being higher than the second capillary force further prevents the fluid to flow from the sample analysis cavity 4 back to the venting cavity 3.

The section view of FIG. 5B shows the cross section of the cuvette seen facing the tip 12 of the cuvette 1. As can be seen, the opening 21 of the sampling cavity 2 and the outlet 31 of the venting cavity 3 are connected, so that the first outer wall of the cuvette at the first end 6 is open over the entire length of the sampling cavity 2 and the venting cavity 3. This allows a shaping tool having on a common shaping core for all the cavities to be removed through the opening 21 and the outlet 31. The first interface 23 is arranged in the longitudinal direction of the cuvette and separates the sampling cavity 2 from the venting cavity 3.

FIG. 6 shows a section view of the cuvette 1 through the cutting plane C-C. As previously discussed, the height of the sampling cavity 3 is smaller than the height of the venting cavity 3. Due to the sampling cavity 2 having a smaller height than the venting cavity, the third capillary force in the sampling cavity 2 is higher than the second capillary force. Thereby, a body fluid sample in the sampling cavity can be prevented from spontaneously flowing from the sampling cavity 2 to the venting cavity 3. The sampling cavity 2 and the venting cavity 3 may be connected by the first interface 23. The first interface 23 may have a smaller height, such as extension in the Z-direction, than both the sampling cavity 2 and the venting cavity 3. The first interface may thus have a fourth capillary force. The fourth capillary force may be higher than the second capillary force and the second capillary force. The first interface 23 may thus be an area adjacent to the sampling cavity 2 that has a very narrow thickness to further ensure that there is no capillary transport from the sampling cavity 2 to the venting cavity 3. The first interface 23 may thus act as a lock preventing the body fluid sample to flow from the sampling cavity 2 to the venting cavity 3. To transport the body fluid sample to the venting cavity 3, a centrifugal force can be applied to the cuvette 1. When the centrifugal force being applied to the cuvette 1 overcomes the third capillary force the body fluid sample may leave the sampling cavity 2 via the first interface 23 and may enter the venting cavity 3, from where the body fluid sample may enter the sample analysis cavity 4.

FIG. 7 shows a section view of the cuvette 1 through the cutting plane D-D. As can be seen in FIG. 7 when comparing it to the section view C-C in FIG. 6, the cross-section area of the sample analysis cavity 4, such as the height and the width of the of the sample analysis cavity 4 is smaller than the cross-section area of the venting cavity 3, thereby causing the sampling cavity 2 to have a higher capillary force than the venting cavity 3. In other words, the venting cavity 3 has a larger cross section area than the sampling cavity 2 and/or the sample analysis cavity 4 in a plane perpendicular to a main plane of the cuvette 1, such as in a plane spanning the Y-axis and the Z-axis. Further, the smaller height and smaller width of the sample analysis cavity 4 compared to the height and the width of the venting cavity 3 allows the parts of the shaping tool being furthest inside the main body member 11 of the cuvette 1 during manufacturing, such as the parts shaping the sample analysis cavity 4, to be removed via the wider outer sections of the cuvette 1, such as via the wider venting cavity 3.

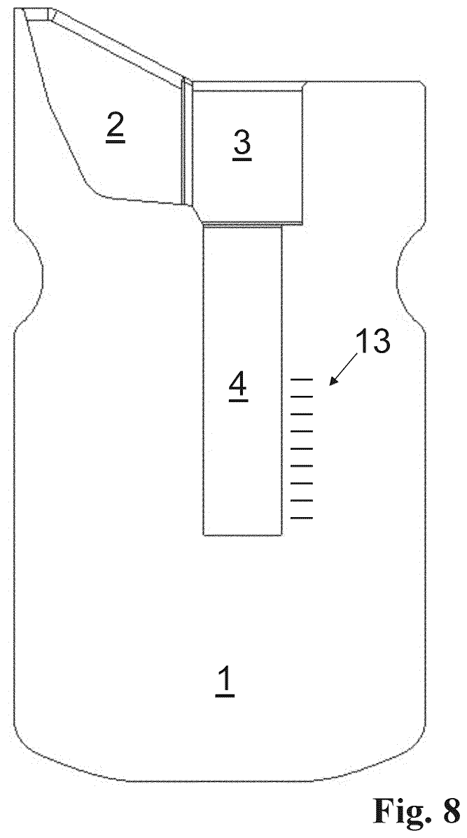

FIG. 8 illustrates the cuvette 1 according to one or more examples of the current disclosure. The cuvette 1 may comprise an indicator 13 for indicating a hematocrit level of the body fluid sample. The indicator 13 may be arranged along an outer periphery of the sample analysis cavity 4. Since the cuvette 1 may be configured for performing separation of a body fluid sample, such as plasma separation of a blood sample, the hematocrit level indicator may be added on the cuvette 1. In one or more example cuvettes, the cuvette is configured to perform the separation of the body fluid sample in the sample analysis cavity 4. In other words, the blood sample may be separated and analyzed in the sample analysis cavity 4. The sampling cavity 2 is configured to extract a precise body fluid volume and the cuvette 1 is configured to transport the entire sample from the sampling cavity 2 to the sample analysis cavity 4. Thereby, a known volume of body fluid may be provided to the sample analysis cavity 4. Therefore, the indicator 13 may comprise measurement lines added onto the main body member 10 of the cuvette 1 to provide a visual indication of the hematocrit level. The indicator may be added by laser welding in the cuvette or during a molding procedure of the cuvette.

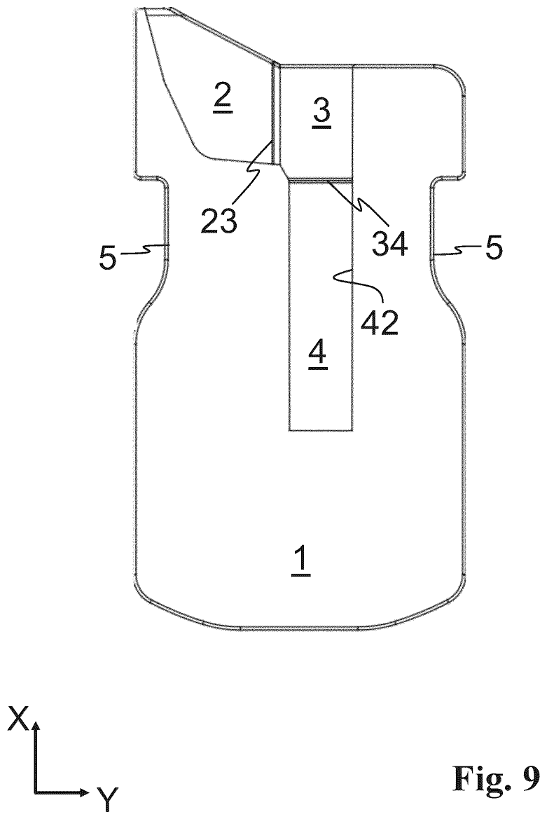

FIG. 9 illustrates a cuvette 1 according to one or more examples of the current disclosure. The example cuvette 1 according to FIG. 9 comprises the sampling cavity 2, the sample analysis cavity 4 and the venting cavity 3. The venting cavity 3 is in fluid connection with the sampling cavity 2 and the sample analysis cavity 4, such that a body fluid can flow from the sampling cavity 2 to the sample analysis cavity 4 via the venting cavity 3. The venting cavity 3 is fluidly connected with the sampling cavity 2 via a first interface 23. The first interface 23 may be arranged along a longitudinal axis of the cuvette 1. The venting cavity 3 may be fluidly connected with the sample analysis cavity 4 via the second interface 34. The second interface 34 may be arranged along a lateral axis of the cuvette 1. The sampling cavity 2 and the sample analysis cavity 4 are not in direct fluid communication with each other. The sample analysis cavity 4 is configured to provide a first capillary force, the first capillary force being higher than a second capillary force provided by the venting cavity 3. This may be achieved by the height, such as a gap depth, of the sample analysis cavity 4 being smaller than the height, such as the gap depth, of the venting cavity 3. In the example cuvette 1 of FIG. 9, the width of the venting cavity 3 at the second interface 34 is equal to the width of the sample analysis cavity 4, so that an inner distal sidewall 32 opposite the first interface 23 of the venting cavity 3 is flush with an inner distal sidewall 42 of the sample analysis cavity 4. Distal can herein be seen as furthest away from the sampling cavity 2. By arranging the inner distal sidewall 32 of the venting cavity 3 flush with the inner distal sidewall 42 of the sample analysis cavity 4, any nooks or corners may be eliminated at the transition between the venting cavity 3 and the sample analysis cavity 4. This provides a better fluid flow between the venting cavity 3 and the sample analysis cavity 4 and reduces the risk of the body fluid getting trapped in the venting cavity 3 and not reaching the sample analysis cavity 4. Thereby, a larger portion of the body fluid sample introduced into the cuvette 1 via the sampling cavity can be used for the analysis of the body fluid in the sample analysis cavity, which can improve the result of the analysis. As in the example cuvette disclosed in FIG. 2-8, the height of the venting cavity 3 is larger than the height of the sample analysis cavity 4, such that the capillary force of the sample analysis cavity 4 is higher than the capillary force of the venting cavity 3. The example cuvette 1 of FIG. 9 further comprises the mounting elements 5 for mounting the cuvette 1 to the analysis apparatus.

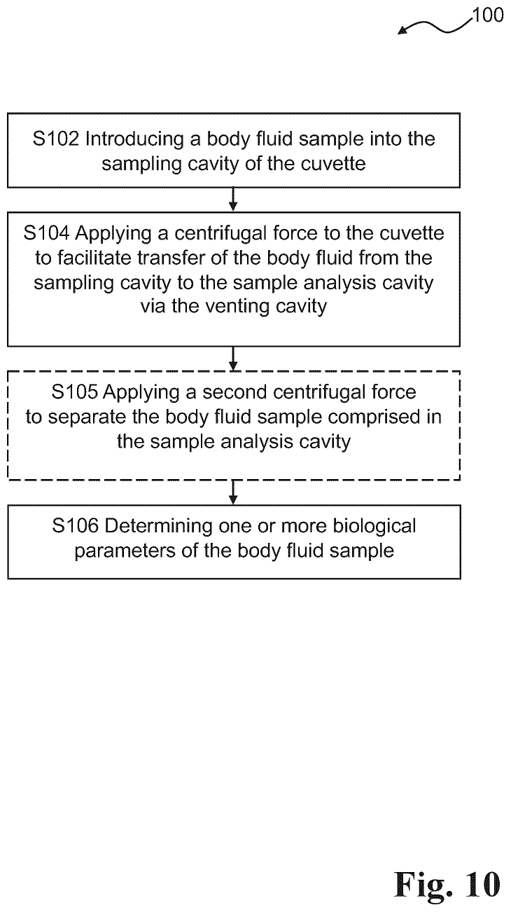

FIG. 10 discloses a method 100 for determining one or more biological parameters of a sample of a body fluid, such as a body fluid sample. The method comprises introducing S102 a sample of a body fluid into the sampling cavity of the cuvette as disclosed herein. The method comprises applying S104 a centrifugal force, such as a first centrifugal force, to the cuvette thereby facilitating transfer of the body fluid from the sampling cavity to the sample analysis cavity via the venting cavity. In one or more example methods, the method comprises applying S105 a second centrifugal force, once the body fluid sample has entered the sample analysis cavity, to separate the body fluid sample comprised in the sample analysis cavity. The body fluid sample may thus be separated in the sample analysis cavity. The method comprises determining S106 one or more biological parameters of the body fluid sample. Determining the one or more biological parameters of the body fluid sample may be done when the body fluid sample is in the sample analysis cavity.

It shall be noted that the features mentioned in the embodiments described in FIGS. 1-10 are not restricted to these specific embodiments. Any features of the cuvette and the components comprised therein and mentioned in relation to the FIGS. 2-7, such as dimensions of the cuvette and/or the cavities, are thus also applicable to the cuvette described in relation to FIGS. 1 and 8, and vice versa.

Embodiments of products (cuvette, manufacturing method, shaping tool and method for determining one or more biological parameters of a sample of a body fluid) according to the disclosure are set out in the following items:
Item 1. A cuvette for body fluid analysis, the cuvette comprising:
   a sampling cavity comprising a fluid inlet;
   a sample analysis cavity; and
   a venting cavity in fluid connection with the sampling cavity and the sample analysis cavity, wherein the venting cavity has an outlet to the exterior of the cuvette,
wherein the cuvette is configured to transfer, upon a centrifugal force being applied to the cuvette, a body fluid from the sampling cavity to the sample analysis cavity via the venting cavity, and
wherein the sample analysis cavity is configured to provide a first capillary force,
wherein the first capillary force is higher than a second capillary force provided by the venting cavity.
Item 2. The cuvette according to Item 1, wherein the cuvette is configured to transfer, when a centrifugal force is applied to the cuvette, air from the sample analysis cavity to an exterior of the cuvette via the venting cavity.
Item 3. The cuvette according to Item 1 or 2, wherein the cuvette is configured to transfer, when a body fluid is introduced into the sampling cavity, air from the sampling cavity to an exterior of the cuvette via the venting cavity.
Item 4. The cuvette according to any one of the preceding Items, wherein the cuvette is configured to prevent the body fluid from leaving the sample analysis cavity after the centrifugal force is removed.
Item 5. The cuvette according to any one of the preceding Items, wherein the sampling cavity and the sample analysis cavity have equal volumes.
Item 6. The cuvette according to any one of the preceding Items, wherein the sampling cavity is configured to provide a third capillary force, wherein the third capillary force is higher than a second capillary force provided by the venting cavity.
Item 7. The cuvette according to any one of the preceding Items, wherein the sample analysis cavity has a substantially uniform elongated shape extending in a first direction from a first end to an opposing second end of the cuvette.
Item 8. The cuvette according to Item 7, wherein the outlet of the venting cavity to the exterior of the cuvette is arranged at the first end of the cuvette.
Item 9. The cuvette according to any one of the preceding Items, wherein the cuvette has a first interface fluidly connecting the venting cavity with the sampling cavity, wherein the first interface is configured to allow the body fluid sample to flow through the first interface when a centrifugal force overcoming the third capillary force is applied to the cuvette.
Item 10. The cuvette according to Item 9, wherein the cuvette has a second interface fluidly connecting the venting cavity with the sample analysis cavity, wherein the second interface is configured to allow the body fluid sample to flow through the second interface.
Item 11. The cuvette according to any one of the Items 9 or 10, wherein the venting cavity has a larger cross section area than the sampling cavity and/or the sample analysis cavity in a plane perpendicular to a main plane of the cuvette.
Item 12. The cuvette according to Item 11, wherein the cross section of the venting cavity has a larger width and/or larger height than a cross section of the sampling cavity and/or the sample analysis cavity in a plane perpendicular to a main plane of the cuvette.
Item 13. The cuvette according to any one of the Items 9 to 12, wherein the first interface and the second interface are arranged at an angle to each other.
Item 14. The cuvette according to any one of the preceding Items, wherein the cuvette consists of a single body member having inner walls defining the sampling cavity, the sample analysis cavity, and the venting cavity within the body.
Item 15. The cuvette according to Item 14, wherein the body member comprises a tip and wherein the sampling cavity is arranged at the tip of the body member.
Item 16. The cuvette according to any one of the preceding Items, wherein the sampling cavity is configured to slope towards the sample analysis cavity.
Item 17. The cuvette according to any one of the preceding Items, wherein the sample analysis cavity is free of reagents.
Item 18. The cuvette according to any one of the preceding Items, wherein the cuvette comprises an indicator for indicating a hematocrit level of the body fluid sample.
Item 19. The cuvette according to Item 18, wherein the indicator is arranged along an outer periphery of the sample analysis cavity.
Item 20. The cuvette according to any one of the preceding Items, wherein the venting cavity has an opening through an outer side wall of the cuvette, said opening extending over an entire width of the venting cavity.
Item 21. The cuvette according to any one of the preceding Items, wherein the sampling cavity has an opening through the outer side wall of the cuvette, said opening extending over an entire width of the sampling cavity.
Item 22. A method of manufacturing a cuvette for taking up a body fluid sample and for analyzing the body fluid sample, said method comprising:
   providing a cuvette base material, from which the cuvette is to be formed,
   shaping, from the cuvette base material, a cuvette using at least one shaping tool, wherein the shaping tool is arranged extending into said cuvette base material for forming the cuvette having:
   a sampling cavity comprising a fluid inlet;
   a sample analysis cavity; and
   a venting cavity in fluid connection with the sampling cavity and the sample analysis cavity, and
withdrawing the shaping tool through an outer side wall of the cuvette.
Item 23. The method according to Item 22, wherein the method comprises applying an indicator for indicating a hematocrit level of a body fluid sample on the cuvette.
Item 24. The method according to Item 23, wherein the applying of the indicator is performed by means of laser welding.
Item 25. The method according to any one of the Items 22 to 24, wherein the shaping of the cuvette is performed by means of injection molding.
Item 26. A shaping tool for forming a cuvette, said shaping tool being configured for insertion into a cuvette base material for forming cavities in the base material and being further configured to be withdrawn from the cuvette base material when the cavities have been formed, said shaping tool comprising:
   a sampling cavity part having an inverse shape of a sampling cavity of the cuvette,
   a sample analysis cavity part having an inverse shape of a sample analysis cavity of the cuvette, and
   a venting cavity part having an inverse shape of a venting cavity of the cuvette, said venting cavity part being connected to the sampling cavity part and the sample analysis cavity part.
Item 27. The shaping tool according to Item 26, wherein the sampling cavity part, the sample analysis cavity part, and the venting cavity part are arranged on a common shaping core.
Item 28. The shaping tool according to Item 26 or 27, wherein a thickness of the venting cavity part is larger than a thickness of the sampling cavity part and/or the sample analysis cavity part.
Item 29. A method of determining one or more biological parameters of a sample of a body fluid, the method comprising:
   introducing (S102) a sample of a body fluid in the sampling cavity of a cuvette according to any one of the Items 1-21;
   applying (S104) a centrifugal force to the cuvette thereby facilitating transfer of the body fluid from the sampling cavity to the sample analysis cavity via the venting cavity; and
   determining (S106) one or more biological parameters of the sample.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It is to be noted that the word “comprising” does not necessarily exclude the presence of other elements or steps than those listed.

It is to be noted that the words “a” or “an” preceding an element do not exclude the presence of a plurality of such elements.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A cuvette for body fluid analysis, the cuvette comprising:
a sampling cavity comprising a fluid inlet;
a sample analysis cavity; and
a venting cavity in fluid connection with the sampling cavity and the sample analysis cavity, wherein the venting cavity has an outlet to an exterior of the cuvette,
wherein the cuvette is configured to transfer, upon a centrifugal force being applied to the cuvette, a body fluid sample from the sampling cavity to the sample analysis cavity via the venting cavity,
wherein the sample analysis cavity is configured to provide a first capillary force, wherein the first capillary force is higher than a second capillary force provided by the venting cavity, and
wherein the sample analysis cavity is configured for separating and analyzing the body fluid sample.

2. The cuvette according to claim 1, wherein the cuvette is configured to transfer, when the centrifugal force is applied to the cuvette, air from the sample analysis cavity to the exterior of the cuvette via the venting cavity.

3. The cuvette according to claim 1, wherein the cuvette is configured to transfer, when the body fluid sample is introduced into the sampling cavity, air from the sampling cavity to the exterior of the cuvette via the venting cavity.

4. The cuvette according to claim 1, wherein the cuvette is configured to prevent the body fluid sample from leaving the sample analysis cavity after the centrifugal force is removed.

5. The cuvette according to claim 1, wherein the sampling cavity and the sample analysis cavity have equal volumes.

6. The cuvette according to claim 1, wherein the sampling cavity is configured to provide a third capillary force, wherein the third capillary force is higher than the second capillary force provided by the venting cavity.

7. The cuvette according to claim 1, wherein the sample analysis cavity has a substantially uniform elongated shape extending in a first direction from a first end to an opposing second end of the cuvette.

8. The cuvette according to claim 7, wherein the outlet of the venting cavity to the exterior of the cuvette is arranged at the first end of the cuvette.

9. The cuvette according to claim 6, wherein the cuvette has a first interface fluidly connecting the venting cavity with the sampling cavity, wherein the first interface is configured to allow the body fluid sample to flow through the first interface when a centrifugal force overcoming the third capillary force is applied to the cuvette.

10. The cuvette according to claim 9, wherein the cuvette has a second interface fluidly connecting the venting cavity with the sample analysis cavity, wherein the second interface is configured to allow the body fluid sample to flow through the second interface.

11. The cuvette according to claim 9, wherein the venting cavity has a larger cross section area than the sampling cavity and/or the sample analysis cavity in a plane perpendicular to a main plane of the cuvette.

12. The cuvette according to claim 11, wherein the cross section of the venting cavity has a larger width and/or larger height than a cross section of the sampling cavity and/or the sample analysis cavity in the plane perpendicular to the main plane of the cuvette.

13. The cuvette according to claim 10, wherein the first interface and the second interface are arranged at an angle to each other.

14. The cuvette according to claim 1, wherein the cuvette consists of a single body member having inner walls defining the sampling cavity, the sample analysis cavity, and the venting cavity within the body member.

15. The cuvette according to claim 14, wherein the body member comprises a tip and wherein the sampling cavity is arranged at the tip of the body member.

16. The cuvette according to claim 1, wherein the sampling cavity is configured to slope towards the sample analysis cavity.

17. The cuvette according to claim 1, wherein the sample analysis cavity is free of reagents.

18. The cuvette according to claim 1, wherein the cuvette comprises an indicator for indicating a hematocrit level of the body fluid sample.

19. The cuvette according to claim 18, wherein the indicator is arranged along an outer periphery of the sample analysis cavity.

20. The cuvette according to claim 1, wherein the venting cavity has an opening through an outer side wall of the cuvette, said opening extending over an entire width of the venting cavity.

21. The cuvette according to claim 1, wherein the sampling cavity has an opening through an outer side wall of the cuvette, said opening extending over an entire width of the sampling cavity.

22. A method of manufacturing a cuvette for taking up a body fluid sample and for analyzing the body fluid sample, said method comprising:
providing a cuvette base material, from which the cuvette is to be formed,
shaping, from the cuvette base material, the cuvette using at least one shaping tool, wherein the at least one shaping tool is arranged extending into said cuvette base material for forming the cuvette having:
a sampling cavity comprising a fluid inlet;
a sample analysis cavity; and
a venting cavity in fluid connection with the sampling cavity and the sample analysis cavity, and
withdrawing the at least one shaping tool through an outer side wall of the cuvette.

23. The method according to claim 22, wherein the method further comprises applying an indicator for indicating a hematocrit level of the body fluid sample on the cuvette.

24. The method according to claim 23, wherein the applying of the indicator is performed by laser welding.

25. The method according to claim 22, wherein the shaping of the cuvette is performed by injection molding.

26. A shaping tool for forming a cuvette, said shaping tool being configured for insertion into a cuvette base material for forming cavities in the cuvette base material and being further configured to be withdrawn from the cuvette base material when the cavities have been formed, said shaping tool comprising:
a sampling cavity part having an inverse shape of a sampling cavity of the cuvette,
a sample analysis cavity part having an inverse shape of a sample analysis cavity of the cuvette, and
a venting cavity part having an inverse shape of a venting cavity of the cuvette, said venting cavity part being connected to the sampling cavity part and the sample analysis cavity part.

27. The shaping tool according to claim 26, wherein the sampling cavity part, the sample analysis cavity part, and the venting cavity part are arranged on a common shaping core.

28. The shaping tool according to claim 26, wherein a thickness of the venting cavity part is larger than a thickness of the sampling cavity part and/or the sample analysis cavity part.

29. A method of determining one or more biological parameters of a sample of a body fluid, the method comprising:
introducing the sample of the body fluid in the sampling cavity of the cuvette according to claim 1;
applying the centrifugal force to the cuvette thereby facilitating transfer of the body fluid sample from the sampling cavity to the sample analysis cavity via the venting cavity;
separating the body fluid sample in the sample analysis cavity by further application of another centrifugal force once the body fluid sample has entered the sample analysis cavity; and
during or after applying the another centrifugal force, determining the one or more biological parameters of the body fluid sample.
